(19) United States
(12) Patent Application Publication
(10) Pub. No.: US 2023/0321960 A1
(43) Pub. Date: Oct. 12, 2023

(54) PEELABLE FILM HAVING NANOCLAY

(71) Applicant: BEMIS COMPANY, INC., Neenah, WI (US)

(72) Inventor: Yuan Liu, Apex, NC (US)

(21) Appl. No.: 18/020,146

(22) PCT Filed: Aug. 14, 2020
(86) PCT No.: PCT/US2020/046328

§ 371 Date: Feb. 7, 2023

(51) Int. Cl. B32B 27/32; B32B 7/12; B32B 27/08; B65D 65/40; B32B 27/20; B65D 77/20; B32B 27/34

(52) U.S. Cl. CPC B32B 27/08; B32B 7/12; B32B 27/20; B32B 27/32; B32B 27/34; B65D 65/40; B65D 77/2024; B32B 2250/24; B32B 2264/10; B32B 2270/00; B32B 2307/31; B32B 2307/7376; B32B 2307/748; B32B 2553/00

(57) ABSTRACT

A film includes a heat seal layer. The heat seal layer includes a heat sealable polyolefin matrix, a polyamide dispersed in the matrix, and an organically modified nanociay dispersed in the matrix. The polyamide is present in the heat seal layer in an amount from 15 percent by weight to 45 percent by weight. The organically modified nanoclay is present in the first heat seal layer in an amount from 0.5 percent by weight to 10 percent by weight.

### TECHNICAL FIELD

The present application relates generally to peelable packaging films, such as easy (EZ) peel films.

### BACKGROUND

Many packages employ films that are heat sealed to a substrate, and the film is peelable from the substrate. When the film peels from the substrate by cohesive failure, a white appearance may be visible. The whiteness is often used as visual confirmation of a high-quality seal, with appearance that is not very white or lacking whiteness over the entire previously sealed area being indicative of, or perceived as, a low-quality seal.

Uniform whiteness may be achieved by uniformly distributing a contaminant in a heat seal layer of the film, which contaminant contributes to the peelable characteristics of the film. Uniform distribution of the contaminant may result in uniform peel strength, which may be another feature associated by an end-user as an indicator of a high-quality seal.

While theoretically understood to result in desirable qualities of a peelable seal, uniform distribution of a contaminant in a heat seal polymer matrix may be difficult to achieve in practice. Some publications disclose the desire for uniform distribution of contaminants without providing guidance regarding how to accomplish such uniform distribution.

Films having a relatively wide temperature range over which a heat seal may be formed to result in a suitable peel strength may be desirable. If the temperature range is narrow, tight manufacturing controls may be needed to ensure that the heat seal is repeatedly formed at a suitable temperature. If the seal temperature is too low a poor quality or non-hermetic seal may be formed. If the seal temperature is too high, the peel strength may be too great for an end-user to easily peel the film from the substrate.

Some peelable films have a polyolefin heat seal matrix in which polybutylene is distributed as a contaminant. However, polybutylene is susceptible to changing shape under high heat and shear, and thus may cause processing issues. In addition, easy peel films employing polybutylene may have a relatively narrow temperature range in which the heat seal may be formed to provide a suitable peel strength. Perhaps due to these issues, batch to batch variation of seal strength may result when using a polybutylene as a contaminant.

In some cases, the contaminant may include inorganic material such as talc or clay. However, obtaining sufficient distribution of such inorganic material often requires high concentrations of the inorganic material, as lower concentrations of such materials tend not to evenly distribute in the heat seal polymer matrix.

### BRIEF SUMMARY

This disclosure, among other things, relates to packaging films that are peelable from a substrate. The films may be peelable from the substrate by cohesive failure. The films may comprise relatively uniform distribution of a contaminant in a heat sealable polymer matrix. The films may provide a wide temperature range over which a heat seal may be formed while resulting in a suitable peel strength.

In some aspects disclosed herein, a film comprises a first heat seal layer comprising a heat sealable polyolefin matrix, a polyamide disposed in the matrix, and an organically modified nanoclay dispersed in the matrix. The polyamide is present in the first heat seal layer in an amount from 15 percent by weight to 45 percent by weight. The organically modified nanoclay is present in the first heat seal layer in an amount from 0.5 percent by weight to 10 percent weight.

While not intending to be bound by theory, it is believed that the presence of the polyamide serves to facilitate distribution of the organically modified nanoclay in the polyolefin heat sealable matrix. For example, it has been found that the d-spacing of organically modified nanoclay in the polyolefin matrix may be increased in the presence of the polyamide. Increased d-spacing indicates greater dispersion, which suggests more uniform dispersion.

It has also been found that the films described herein may exhibit a suitable peel strength over a fairly large range of heat seal temperatures.

It is to be understood that both the foregoing general description and the following detailed description present embodiments of the subject matter of the present disclosure, and are intended to provide an overview or framework for understanding the nature and character of the subject matter of the present disclosure as it is claimed. The accompanying drawings are included to provide a further understanding of the subject matter of the present disclosure and are incorporated into and constitute a part of this specification. The drawings illustrate various embodiments of the subject matter of the present disclosure and together with the description serve to explain the principles and operations of the subject matter of the present disclosure. Additionally, the drawings and descriptions are meant to be merely illustrative and are not intended to limit the scope of the claims in any manner.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 is a schematic drawing of a cross-section of a film 10 in accordance with an embodiment described herein;

FIG. 2 is a schematic view of an embodiment of a packaged product 100;

FIG. 3 is a schematic sectional view of an embodiment of a packaged product 100;

FIG. 4 is a graph of seal strength vs. sealing temperature of an embodiment of a film;

FIG. 5 is a graph of seal strength vs. sealing temperature of an embodiment of a film;

FIG. 6 an image of an embodiment of a film as described herein (left) and a polybutylene EZ peel film (right), where the films were sealed to themselves and peeled;

FIG. 7 is a scanning electron micrographic (1000X) image of a peeled surface of an embodiment of a film; and

FIG. 8 is a scanning electron micrographic (1000X) image of a peeled polybutylene EZ peel film.

The schematic drawings are not necessarily to scale. Like numbers used in the figures refer to like components. However, it will be understood that the use of a number to refer to a component in a given figure is not intended to limit the component in another figure labeled with the same number. In addition, the use of different numbers to refer to components is not intended to indicate that the different numbered components cannot be the same or similar to other numbered components.

### DETAILED DESCRIPTION

Reference will now be made in greater detail to various embodiments of the subject matter of the present disclosure, some embodiments of which are illustrated in the accompanying drawings.

The present disclosure relates to, among other things, films that are peelable from a substrate. The films may comprise a first heat seal layer. The first heat seal layer may comprise a heat sealable polyolefin matrix, a polyamide disposed in the matrix, and an organically modified nanoclay dispersed in the matrix.

As used herein, a “heat seal layer” is a layer capable of fusion bonding by conventional indirect heating means which generate sufficient heat on at least one film contact surface for conduction to a contiguous film contact surface and formation of a bond interface therebetween without loss of the film integrity. The bond interface between contiguous inner layers preferably has sufficient physical strength to withstand the packaging process and subsequent handling.

Preferably, the films are peelable from the substrate by cohesive failure. As used herein, “cohesive failure” refers to a fracture within a heat-sealed layer of the film resulting in a portion of the layer remaining on the substrate and a portion of the layer remaining with the peeled film. To achieve cohesive failure, the tensile strength at break of the heat-sealed layer is less than a peel strength to allow the layer to fracture when peeled.

Each of the polyolefin matrix, the polyamide, the organically modified nanoclay, and other components of the heat seal layer, if present, may be selected to have properties conducive for producing a layer having suitable heat seal and peelable properties.

The first heat seal layer may comprise any suitable heat sealable polyolefin matrix. A “polyolefin matrix” refers to a polymer matrix comprising a polyolefin. The matrix may comprise any suitable polyolefin. “Polyolefin” is used herein broadly to include polymers such as polyethylene, ethylene-alpha olefin copolymers (EAO), polypropylene, polybutene, ethylene copolymers having a majority amount by weight of ethylene polymerized with a lesser amount of a comonomer such as vinyl acetate, and other polymeric resins falling in the “olefin” family classification. Polyolefins may be made by a variety of processes well known in the art including batch and continuous processes using single, staged or sequential reactors, slurry, solution and fluidized bed processes and one or more catalysts including for example, heterogeneous and homogeneous systems and Ziegler, Phillips, metallocene, single site and constrained geometry catalysts to produce polymers having different combinations of properties. Such polymers may be highly branched or substantially linear and the branching, dispersity and average molecular weight and may vary depending upon the parameters and processes chosen for their manufacture in accordance with the teachings of the polymer arts.

In some embodiments, the polyolefin matrix comprises one or more of an ionomer, heterogeneous ethylene alpha olefin copolymer, a homogeneous ethylene alpha olefin copolymer, ethylene vinyl acetate copolymer, ethylene methyl acrylate copolymer, ethylene propylene copolymer, polypropylene homopolymer or copolymer, polybutylene homopolymer or copolymer, and blends thereof.

In some embodiments, the polyolefin matrix comprises polyethylene. The term “polyethylene” is used herein (unless indicated otherwise) to refer to ethylene homopolymers as well as copolymers of ethylene with α-olefins and the term will be used without regard to the presence or absence of substituent branch groups.

The polyolefin heat sealable matrix may comprise a “high pressure, low density polyethylene” (LDPE). LDPE is used to denominate branched homopolymers having densities between 0.915 and 0.930 g/cm³. LDPEs typically contain long branches off the main chain (often termed “backbone”) with alkyl substituents of 2 to 8 carbon atoms.

The heat sealable polyolefin matrix may comprise an EAO. EAOs are copolymers having an ethylene as a major component copolymerized with one or more alpha olefins such as octene-1, hexene-, or butene-1 as a minor component. EAOs include polymers known as linear low density polyethylene (“LLDPE”), very low density polyethylene (“VLDPE”), ultralow density polyethylene (“ULDPE”), and plastomers and may be made using a variety of processes and catalysts including metallocene, single-site and constrained geometry catalysts as well as Ziegler-Natta and Phillips catalysts.

Linear Low Density Polyethylene (LLDPE) are copolymers of ethylene with alphaolefins having densities from 0.915 to 0.940 g/cm³. The α-olefin utilized is usually 1-butene, 1-hexene, or 1-octene and Ziegler-type catalysts are usually employed (although Phillips catalysts are also used to produce LLDPE having densities at the higher end of the range, and metallocene and other types of catalysts are also employed to produce other well-known variations of LLDPEs). The LLDPE may be produced with a metallocene or constrained geometry catalyst, which may be referred to as “mLLDPE”.

Very Low Density Polyethylene (VLDPE) and “Ultra Low Density Polyethylene” (ULDPE) are copolymers of ethylene with α-olefins, usually 1-butene, 1-hexene or 1-octene and are recognized by those skilled in the art as having a high degree of linearity of structure with short branching rather than the long side branches characteristic of LDPE. However, VLDPEs have lower densities than LLDPEs. The densities of VLDPEs are recognized by those skilled in the art to range between 0.860 and 0.915 g/cm³. Sometimes VLDPEs having a density less than 0.900 g/cm³ are referred to as “plastomers”.

Some examples of polyethylene that may be particularly well suited for including in the heat seal layers of the films described herein include LDPE, VLDPE, ULDPE, LLDPE, and ethylene vinyl acetate (EVA).

The first heat seal layer may comprise any suitable amount of polyolefin. For example, the first seal layer may comprise from about 45 percent polyolefin by weight to about 85 percent polyolefin by weight, such as from about 55 percent polyolefin by weight to about 80 percent polyolefin by weight.

Preferably, the heat sealable polyolefin matrix comprises a polyolefin or blend that may form a layer having a low tensile strength at break. For example, the polyolefin matrix may have a tensile strength at break of 4.4 pounds per square inch or less, such as about 4 pounds per square inch or less, about 3 pounds per square inch or less, or about 2.75 pounds per square inch or less. The polyolefin matrix may have a tensile strength at break of about 0.5 pounds per square inch or greater, such as about 1 pound per square inch or greater, about 1.5 pounds per square inch or greater, or about 2 pounds per square inch or greater. For purposes of the present disclosure, the tensile strength at break of a polyolefin matrix is the tensile strength at break of a monolayer film formed from the polyolefin matrix in the absence of the polyamide and organically modified nanoclay. It should be understood that the heat seal layer may have a tensile strength at break that is different than tensile strength at break of the polyolefin matrix. For example, dispersing an organically modified nanoclay in the polyolefin matrix may reduce the tensile strength at break. Tensile strength at break may be measured in any suitable manner. For example, tensile strength at break may be measured according to ASTM Standard D638-14, “Standard Test Method for Tensile Properties of Plastics.”

The first heat seal layer may comprise any suitable polyamide. The term “polyamide” means a high molecular weight polymer having amide linkages (--CONH--)ₙ which occur along the molecular chain, and includes “nylon” resins which are well known polymers having a multitude of uses including utility as packaging films, bags, and pouches. See, e.g. Modern Plastics Encyclopedia, 88 Vol. 64, No. 10A, pp 34-37 and 554-555 (McGraw-Hill, Inc., 1987) which is hereby incorporated by reference. In some embodiments, polyamides are preferably selected from nylon compounds approved for use in producing articles intended for use in processing, handling, and packaging food or drugs.

The term “nylon,” as used herein, refers more specifically to synthetic polyamides, either aliphatic or aromatic, either in crystalline, semi-crystalline, or amorphous form characterized by the presence of the amide group --CONH. It is intended to refer to both polyamides and co-polyamides.

Thus the terms “polyamide” or “nylon” encompass both polymers comprising repeating units derived from monomers, such as caprolactam, which polymerize to form a polyamide, as well as copolymers derived from the copolymerization of caprolactam with a comonomer which when polymerized alone does not result in the formation of a polyamide. Preferably, polymers are selected from compositions approved as safe for producing articles intended for use in processing, handling and packaging of food or drugs, such as nylon resins approved by the U.S. Food and Drug Administration provided at 21 CFR §177.1500 (“Nylon resins”), which is incorporated herein by reference. Examples of these nylon polymeric resins for use in food or drug packaging and processing include: nylon 66, nylon 610, nylon 66/610, nylon 6/66, nylon 11, nylon 6, nylon 66T, nylon 612, nylon 12, nylon 6/12, nylon 6/69, nylon 46, nylon 6-3-T, nylon MXD-6, nylon MXDI, nylon 12T and nylon 61/6T disclosed at 21 CFR §177.1500. Examples of such polyamides include nylon homopolymers and copolymers such as those selected form the group consisting of nylon 4,6 (poly(tetramethylene adipamide)), nylon 6 (polycaprolactam), nylon 6,6 (poly(hexamethylene adipamide)), nylon 6,9 (poly(hexamethylene nonanediamide)), nylon 6,10 (poly(hexamethylene sebacamide)), nylon 6,12 (poly(hexamethylene dodecanediamide)), nylon 6/12 (poly(caprolactam-cododecanediamide)), nylon 6,6/6 (poly(hexamethylene adipamide-co-caprolactam)), nylon 66/610 (e.g., manufactured by the condensation of mixtures of nylon 66 salts and nylon 610 salts), nylon 6/69 resins (e.g., manufactured by the condensation of epsilon-caprolactam, hexamethylenediamine and azelaic acid), nylon 11 (polyundecanolactam), nylon 12 (polylauryllactam) and copolymers or mixtures thereof.

The first heat seal layer may comprise an amorphous nylon copolymer. As used herein, the term “amorphous” denotes an absence of a regular three-dimensional arrangement of molecules or subunits of molecules extending over distances which are large relative to atomic dimensions. However, regularity of structure may exist on a local scale. See, “Amorphous Polymers,” Encyclopedia of Polymer Science and Engineering, 2nd Ed., pp. 789-842 (J. Wiley & Sons, Inc. 1985). In particular, the term “amorphous nylon copolymer” refers to a material recognized by one skilled in the art of differential scanning calorimetry (DSC) as having no measurable melting point (less than 0.5 cal/g) or no heat of fusion as measured by DSC using ASTM 3417-83. The amorphous nylon copolymer may be manufactured by the condensation of hexamethylenediamine, terephthalic acid, and isophthalic acid according to known processes. Amorphous nylons also include those amorphous nylons prepared from condensation polymerization reactions of diamines with dicarboxylic acids. For example, an aliphatic diamine is combined with an aromatic dicarboxylic acid, or an aromatic diamine is combined with an aliphatic dicarboxylic acid to give suitable amorphous nylons.

The first heat seal layer may comprise any suitable amount of polyamide. For example, the first heat seal layer may comprise from about 15 percent polyamide by weight to about 45 percent polyamide by weight, such as from about 20 percent polyamide by weight to above 40 percent polyamide by weight.

The first heat seal layer may optionally comprise a compatibilizer. As used herein, a “compatibilizer” is an additive that enhances compatibility of a polyamide with the polyolefin matrix of the heat seal layer. For example, a compatibilizer may facilitate blending of the polyolefin and the polyamide. Any suitable compatibilizer may be used.

For example, the compatibilizer may comprise one or more of an epoxy-modified polystyrene copolymer, an ethylene-ethylene anhydride-acrylic acid copolymer, an ethylene-ethyl acrylate copolymer, an ethylene-alkyl acrylate-acrylic acid copolymer, a maleic anhydride modified (graft) high-density polyethylene, a maleic anhydride modified (graft) polypropylene, a maleic anhydride modified (graft) linear low-density polyethylene, an ethylene-alkyl (meth)acrylate-(meth)acrylic acid copolymer, an ethylene-butyl acrylate copolymer, an ethylene-vinyl acetate copolymer, a maleic anhydride modified (graft) ethylene-vinyl acetate copolymer, and a modification thereof.

An example of a compatibilizer that may be particularly useful to promote compatibilization of polyethylene and polyamide is RETAIN™ 3000 functional polymer available from Dow (Midland, Michigan).

The first heat seal layer may comprise any suitable amount of a compatibilizer. For example, if a compatibilizer is present, the first heat seal layer may comprise from about 0.5 percent compatibilizer by weight to about 10 percent compatibilizer by weight.

The first heat seal layer may comprise any suitable organically modified nanoclay. As used herein, an “organically modified nanoclay” is a clay in which exchangeable inorganic cations are replaced with organic cations and has a particle size from about 1 nanometer to about 10,000 nanometers, such as from about 100 nanometers to about 2,000 nanometers, from about 200 nanometers to about 1,000 nanometers or from about 200 nanometers to about 500 nanometers. Organically modified nanoclays may be prepared by reacting a clay with an organic cation or cations provided by specific quaternary ammonium compounds.

Organically modified nanoclays may be more easily dispersed in a polymer than an untreated clay. Preferably, the organically modified nanoclay has an exfoliated structure. Exfoliated organically modified nanoclays may be exfoliated or separated by, for example, mechanical mixing, such as shear mixing, and may be highly dispersed through the heat seal layer. The organically modified nanoclay may comprise intercalated organically modified nanoclay. However, intercalated organically modified nanoclay may not be as conducive to dispersion as exfoliated organically modified nanoclay due to the intercalation.

In some embodiments, the organically modified nanoclay comprises substituted alkyl side chains. The substituted alkyl side chains may result in improved compatibility of the organically modified naonclay and the polyolefin in the heat seal layer.

The organically modified clay may comprise any suitable nanoclay mineral. For example, the organically modified nanoclay may comprise one or more of smectite, vermiculite, halloysite, or any synthetic analogs or combinations thereof. Preferably, the organically modified nanoclay comprises a smectite-type clay. Suitable smectite-type clays include montmorillonite, hectorite, bentonite, beidellite, stevensite, saponite, nontronite, sauconite, sobokite, and svinfordite.

In some embodiments, the organically modified nanoclay comprises a cation-exchangeable smectite clay having a cation exchange capacity of at least 75 miliequivalents per 100 grams of clay, 100 percent active basis (i.e., beneficiated and essentially free of non-clay impurities). Smectite-type clays are well known in science, geology and in the art of rheological additives, and are commercially available from a variety of sources both in the United States and throughout the world. They are unique among clays in that they exhibit the phenomena of swelling to many times their size when contacted with water.

The organically modified nanoclays may result from reaction with any suitable organic cation. For example, the organic cations may comprise a nitrogen-based quaternary material capable of exchanging cations with the clay, the selected smectite-type clay. The organic cations which are reacted with the smectite-type clay to prepare the organically modified nanoclays may have a positive charge localized on a single nitrogen atom within the compound. For example, the organic cation may comprise a quaternary ammonium compound derived from an organic acid ester. The quaternary ammonium compound may comprise one or more of (i) an alkyl or aralkyl-ester group having 8 to 30 carbon atoms; (ii) a linear or branched alkyl (including methyl), an aliphatic, or an aromatic group having 1 to 30 carbon atoms (such groups can also include hydroxylaryl groups); (iii) an aralkyl group, such as benzyl and substituted benzyl moieties, including such groups having fused ring moieties having linear chains or branches of 1 to 30 carbon atoms; (iv) an aryl group such as phenyl and substituted phenyl including fused ring aromatic substituents; (v) beta, gamma-unsaturated groups having six or less carbon atoms or hydroxyalkyl groups having 2 to 6 carbon atoms; and (vi) hydrogen. The quaternary ammonium compound may be a salt. The counter ion may comprise chloride, methyl sulfate, acetate, iodide, bromide, and the like.

In some embodiments, the first heat seal layer comprises organically modified nanoclay and includes no other, or substantially no other, inorganic additive. For example, the first heat seal layer may comprise less than 5%, less than 2%, less than 1%, less than 0.5% by weight of an inorganic additive other than the organically modified nanoclay.

The first heat seal layer may comprise any suitable amount of organically modified nanoclay. For example, the first heat seal layer may comprise from about 0.5 percent by weight organically modified nanoclay to about 10 percent by weight organically modified nanoclay, such as from about 1 percent by weight organically modified nanoclay to about 5 percent by weight organically modified nanoclay, or from about 2 percent by weight organically modified nanoclay to about 4 percent by weight organically modified nanoclay.

The first heat seal layer may be formed in any suitable manner. Preferably, a blend of the polyolefin, the polyamide, the organically modified nanoclay, and the optional compatibilizer is mixed to distribute the organically modified nanoclay in the polyolefin matrix. While not intending to be bound by theory, it is believed that the polyamide may enhance distribution of the organically modified nanoclay in the polyolefin matrix. Interaction of the organically modified nanoclay with a polar polyamide may facilitate distribution of the nanoclay. The presence of the optional compatibilizer may facilitate distribution of the polyamide in the polyolefin matrix.

The first heat seal layer may be formed in any suitable manner from the blended materials. For example, the first heat seal layer may be formed by using cast film techniques, blown film techniques, extrusion, co-extrusion, extrusion coating, blow molding, cast molding, extrusion, extrusion coating, lamination, blow molding, simultaneous film stretching, film blowing, and the like.

The organically modified nanoclay may be distributed in the resulting first heat seal layer to any suitable degree. Preferably, the organically modified nanoclay is more widely dispersed in the resulting first heat seal layer than if dispersed in a substantially similar heat seal layer that does not include polyamide. Dispersion of the organically modified clay in the first heat seal layer may be determined in any suitable manner. For example, dispersion of the organically modified nanoclay may be determined by determining d-spacing of the organically modified nanoclay.

The d-spacing of the organically modified nanoclay may be determined via X-ray diffraction. The d-spacing is the distance between planes of atoms that give rise to diffraction peaks. Diffraction peaks may be obtained from a diffractogram, which may be obtained via X-Ray Powder Diffraction (XRD) measurement. Each peak in a diffractogram results from a corresponding d-spacing. The planes of atoms may be referred to a 3D coordinate system and thus may be described as a direction within the crystal. In some embodiments, d-spacing of the organically modified clay in the first heat seal layer is 40 Angstroms or greater, such as 42 Angstroms or greater.

The first heat seal layer preferably results in a film that has a suitable peel strength over a fairly large range of heat seal temperatures. For example, the film may provide an average peel strength from about 900 grams per inch to about 1200 grams per inch when heat sealed to itself for 1 second at 40 pounds per square inch at a temperature in a range from 280° F. to 330° F. In some embodiments, the film provides an average peel strength from 900 grams per inch to 1200 grams per inch when heat sealed to itself for 1 second at 40 pounds per square inch at a temperature in a range from 270° F. to 350° F.

As used herein, “peel strength” refers to the force required to separate two layers. Peel strength may be tested in any suitable matter. For example, peel strength may be determined as described in ASTM F-88/F-88 - 09, “Standard Test Method for Seal Strength of Flexible Barrier Materials.”

The films described herein preferably have a peel strength in a range from about 200 grams per inch to about 2000 grams per inch. Such peel strengths are generally understood by those of skill in the packaging arts to be considered easy (EZ) peel films.

The first heat seal layer may be of any suitable thickness. In some embodiments, the first heat seal layer has a thickness from about 0.2 mil (5.8 micrometers) to about 2 mil (50.8 micrometers).

### Additional Film Layers

Any suitable film may comprise a first heat seal layer as described herein. The film may comprise one or more additional layers. The term “layer” refers to a discrete component of the film that has a substantially uniform composition. A layer may or may not be coextensive with the film.

A layer may comprise a polymer. As used herein, a “polymer” refers to a material that is the product of polymerization or copolymerization of natural, synthetic or combined natural and synthetic monomers or co-monomers, or monomers and co-monomers, and is inclusive of homopolymers, copolymers, terpolymers, and the like. A layer may comprise a single polymer, a mixture of a polymer and non-polymeric material, a combination of two or more polymers blended together, or a mixture of two or more polymers and non-polymeric material.

The film may comprise any suitable number of layers. For example, the film may comprise a second heat seal layer, at least one functional layer, and a tie layer. The at least one functional layer may be an abuse-resistant layer, an intermediate layer, a barrier layer, a bulk layer, or the like.

If the film comprises a second heat seal layer, the second heat seal layer is preferably disposed on the first heat seal layer such that the second layer defines an exterior layer of the film. If the film does not contain a second heat seal layer, the first heat seal layer may define the exterior layer of the film.

The second heat seal layer may comprise a polyolefin polymer matrix as described above. Preferably, the second heat seal layer consists essentially of a polyolefin polymer or a blend of polyolefin polymers.

The second heat seal layer, if present, may have any suitable thickness. For example, the second heat seal layer may have a thickness from about 0.2 mil (5.8 micrometers) to about 2 mil (50.8 micrometers).

The films described herein may comprise an outer layer, which is a generally opposing layer of the first or second heat seal layer. Since the outer layer of the film may be seen by a user, the exterior surface of the outer layer of the film preferably has desirable optical properties such as matte or gloss effects. Also, the exterior surface of the outer layer preferably withstands contact with sharp objects and provides abrasion resistance. As the exterior surface layer of the film, this layer most often is also the exterior layer of any package of which the film forms at least a portion, and therefore may be subject to handling and abuse e.g. from equipment during packaging, and from rubbing against other packages and shipping containers and storage shelves during transport and storage.

The exterior surface layer should be easy to machine (i.e. be easy to feed through and be manipulated by machines e.g. for conveying, packaging, printing or as part of the film or packaging manufacturing process). Suitable stiffness, flexibility, flex crack resistance, modulus, tensile strength, coefficient of friction, printability, and optical properties are also frequently designed into exterior layers by suitable choice of materials. This layer may also be chosen to have characteristics suitable for creating desired heat seals which may be resistance to burn through e.g. by impulse sealers or may be used as a heat sealing surface in certain package embodiments e.g. using overlap seals.

Suitable exterior surface layers may comprise: oriented polyester, amorphous polyester, polyamide, polyolefin, cast or oriented nylon, polypropylene, or copolymers, or blends thereof. Oriented films of this or any other layer may be either uni-axially or bi-axially oriented. The exterior layer thickness is typically 0.5 mil (12.7 micrometers) to about 2 mil (50.8 micrometers). Thinner layers may be less effective for abuse resistance, however thicker layers, though more expensive, may advantageously be used to produce films having unique highly desirable puncture resistance and/or abuse resistance properties.

A film described herein may comprise an intermediate layer. An intermediate layer is any layer between two other layers and may include barrier layers, tie layers, or layers having functional attributes useful for the film structure or its intended uses. Intermediate layers may be used to improve, impart or otherwise modify a multitude of characteristics: e.g. printability for trap printed structures, machinability, tensile properties, flexibility, thermoformability, stiffness, modulus, designed delamination, easy opening features, tear properties, strength, elongation, optical, moisture barrier, oxygen or other gas barrier, radiation selection or barrier e.g. to ultraviolet wavelengths, etc. Suitable intermediate layers may include: adhesives, adhesive polymers, oriented polyester, amorphous polyester, polyamide, polyolefin, nylon, polypropylene, or copolymers, or blends thereof. Suitable polyolefins may include: polyethylene, ethylene-alpha olefin copolymers (EAO), polypropylene, polybutene, ethylene copolymers having a majority amount by weight of ethylene polymerized with a lesser amount of a comonomer such as vinyl acetate, and other polymeric resins falling in the “olefin” family classification, low density polyethylene (LDPE), high density polyethylene (HDPE), linear low density polyethylene (LLDPE), ethylene methacrylic acid (EMA), ethylene acrylic acid (EAA), modified polyolefins e.g. anhydride grafted ethylene polymers, etc.

A film as described herein may comprise one or more adhesive layers, also known in the art as “tie layers,” which can be selected to promote the adherence of adjacent layers to one another in a multilayer film and prevent undesirable delamination. A multifunctional layer is preferably formulated to aid in the adherence of one layer to another layer without the need of using separate adhesives by virtue of the compatibility of the materials in that layer to the first and second layers. In some embodiments, adhesive layers comprise materials found in both the first and second layers.

Multilayer films can comprise any suitable number of tie or adhesive layers of any suitable composition. Various adhesive layers are formulated and positioned to provide a desired level of adhesive between specific layers of the film according to the composition of the layers contacted by the tie layers.

The interior, exterior, intermediate or tie layers may be formed of any suitable thermoplastic materials, for example, polyamides, polystyrenes, styrenic copolymers e.g. styrene-butadiene copolymer, polyolefins, and in particular members of the polyethylene family such as LLDPE, VLDPE, high density polyethylene (HDPE), LDPE, cyclic olefin copolymer (COC), ethylene vinyl ester copolymer or ethylene alkyl acrylate copolymer, polypropylenes, ethylene-propylene copolymers, ionomers, polybutylenes, alpha-olefin polymers, polyesters, polyurethanes, polyacrylamides, anhydride-modified polymers, acrylate-modified polymers, polylactic acid polymers, or various blends of two or more of these materials.

Various additives may be included in the polymers utilized in one or more of the exterior, interior and intermediate or tie layers of the film. Conventional anti-oxidants, antiblock additives, polymeric plasticizers, acid, moisture or gas (such as oxygen) scavengers, slip agents, colorants, dyes, pigments, organoleptic agents may be added to one or more film layers of the film or the film may be free from such added ingredients.

A film described herein may have any suitable thickness. In some embodiments, the film has a total thickness of less than about 50 mil (1270 micrometers), more preferably the film has a total thickness of from about 1.0 mil (25.4 micrometers) to about 10 mil (254 micrometers), such as from about 1 mil (25.4 micrometers) to about 5 mil (127 micormeters), or from about 2 mil (50.8 micrometers) to about 3.5 mil (88.9 micrometers). For example, entire multilayer films or any single layer of a multilayer film can have any suitable thicknesses, including 1, 2, 3, 4, 5, 6, 7, 8, 9, 10, or 50 mil, or any increment of 0.1 or 0.01 mil therebetween.

In some embodiments, the films are as thick as 50 mil (1270 micrometers) or higher, or as thin as 1 mil (25.4 micrometers) or less. In various embodiments, the packaging films have a thickness of between about 2 mil (50.8 micrometers) to about 4 mil (101.6 microns).

The films described herein may be made in any suitable manner, such as by conventional processes. Processes to produce flexible films may include e.g. cast or blown film processes, or extruding processes.

### Packages and Packaged Products

Packages may be formed from films in any suitable manner. For example, the packages may be formed by heat sealing the first heat seal layer or the second heat seal layer, if present, to a substrate. The substrate may comprise, for example, the film itself (e.g., the first or second heat seal layer may be sealed to itself), to another suitable film, or to another suitable structure. In some embodiments, the film is heat sealed across an opening of a container.

Any suitable articles may be packaged in a package described herein. As an example, a food product, a medical device, or a pharmaceutical product may be packaged in a package described herein.

A packaged product may comprise a product, a film as described herein, and optionally a packaging structure. The film may be heat sealed to itself or the package structure to define an interior space. The product may be disposed in the interior space.

With the above general discussion in mind, reference in now made to the embodiments shown in the figures.

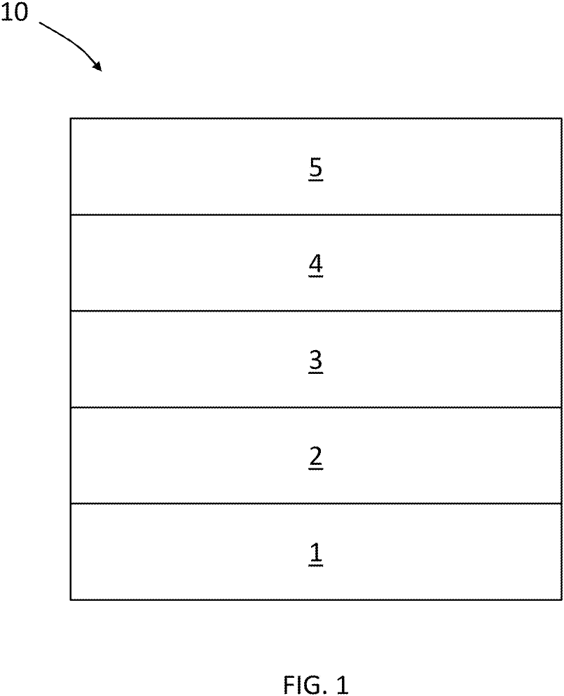

Referring to FIG. 1, a schematic drawing of a cross-section of a film 10 in accordance with an embodiment described herein. In the depicted embodiment, the film 10 includes five layers. On one surface is a second heat seal layer 1, which comprises a polyolefin. Preferably, the second heat seal layer consists essentially of the polyolefin plus only minimal additives for processing. Adjacent to and in contact with the second heat seal layer 1 is a first heat seal layer 2, which comprises a heat sealable polyolefin matrix, a polyamide dispersed in the matrix, and an organically modified nanoclay dispersed in the matrix. Adjacent to and in contact with the second heat seal layer 2 is a bulk layer 3, which may be a polyolefin bulk layer. Adjacent and in contact with the bulk layer 3 is a tie layer 4. Adjacent to and in contact with the tie layer 4 is an exterior protective layer 5. It will be understood that a film as described herein may have any number of one or more layers and that the five-layered film depicted in FIG. 1 is shown for purposes of example.

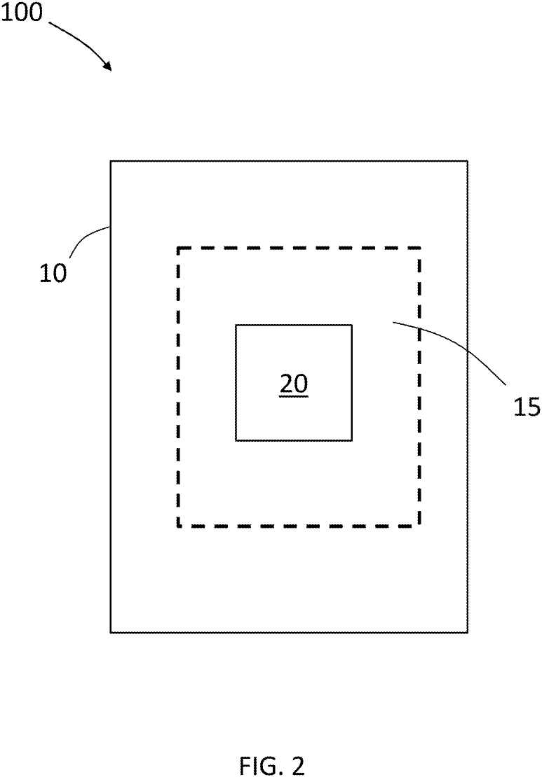

Referring now to FIG. 2, a schematic view of an embodiment of a packaged product 100 is shown. In the depicted embodiment, the packaged product 100 includes a product 20 sealed in a film 10 as described herein. The dashed lines in FIG. 2 represent the boundaries of an interior volume 15 formed by the film 10 (in this case, wrapped around the product 20 and sealed around the perimeter).

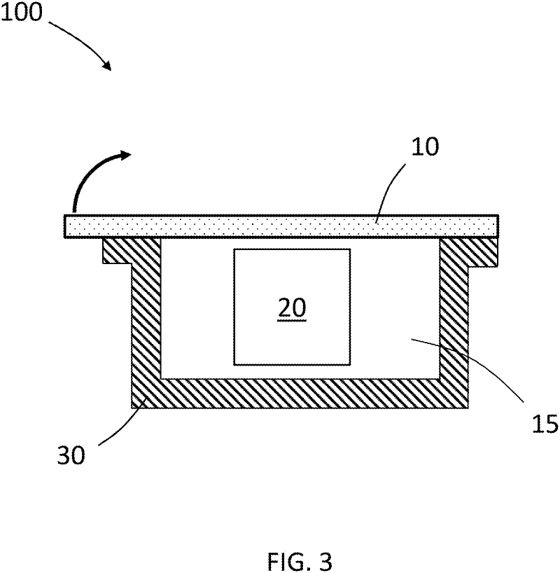

Referring now to FIG. 3, a schematic sectional view of an embodiment of a packaged product 100 is shown. In the depicted embodiment, the packaged product 100 includes a container 30 comprising a lip to which a film 10 is sealed to define a sealed interior volume 15 in which a product 20 is disposed. The film 10 may be peeled from the container 30 as indicated by the arrow in FIG. 3.

As used herein, singular forms “a,” “an” and “the” include plural referents unless the context clearly dictates otherwise. Thus, for example, reference to a “structured bottom surface” includes examples having two or more such “structured bottom surfaces” unless the context clearly indicates otherwise.

As used herein, the term “or” is generally employed in its sense including “and/or” unless the content clearly dictates otherwise. The term “and/or” means one or all of the listed elements or a combination of any two or more of the listed elements. The use of “and/or” in certain instances herein does not imply that the use of “or” in other instances does not mean “and/or”.

As used herein, “have”, “has”, “having”, “include”, “includes”, “including”, “comprise”, “comprises”, “comprising” or the like are used in their open ended inclusive sense, and generally mean “include, but not limited to”, “includes, but not limited to”, or “including, but not limited to”.

“Optional” or “optionally” means that the subsequently described event, circumstance, or component, can or cannot occur, and that the description includes instances where the event, circumstance, or component, occurs and instances where it does not.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the inventive technology.

For purposes of the present disclosure, recitations of numerical ranges by endpoints include all numbers subsumed within that range (e.g., 1 to 5 includes 1, 1.5, 2, 2.75, 3, 3.80, 4, 5, etc.). Where a range of values is “greater than”, “less than”, etc. a particular value, that value is included within the range.

Any direction referred to herein, such as “top,” “bottom,” “left,” “right,” “upper,” “lower,” “above,” below,” and other directions and orientations are described herein for clarity in reference to the figures and are not to be limiting of an actual device or system or use of the device or system. Many of the devices, articles or systems described herein may be used in a number of directions and orientations.

A “polyolefin,” “polyethylene,” or “polyamide” are inclusive of not only polymers comprising repeating units derived from monomers known to polymerize to form a polymer of the named type, but are also inclusive of comonomers, as well as both unmodified and modified polymers made by e.g. derivatization of a polymer after its polymerization to add functional groups or moieties along the polymeric chain. Furthermore, terms identifying polymers are also inclusive of “blends” of such polymers. For example, the terms “polyamide polymer” and “nylon polymer” may refer to a polyamide-containing homopolymer, a polyamide-containing copolymer or mixtures thereof.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred. Any recited single or multiple feature or aspect in any one claim can be combined or permuted with any other recited feature or aspect in any other claim or claims.

It is also noted that recitations herein refer to a component being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a film comprising a polyolefin, a polyamide, and an organically modified nanoclay include embodiments where a film consists of a polyolefin, a polyamide, and an organically modified nanoclay and embodiments where a product-contacting layer consists essentially of a polyolefin, a polyamide, and an organically modified nanoclay.

### EXAMPLES

Following are examples given to illustrate the invention, but these examples should not be taken as limiting the scope. All percentages are by weight unless indicated otherwise.

A number of films were made and tested for their ability to seal and peel. The films had heat seal layers made from virgin resins or recycled resins. The heat seal layers made from virgin resins included from 1 to 5% by weight organically modified nanoclay (Nanomer® I.40P or I.44P nanoclays, which are di-methyl, di-hydrogenated tallow ammonium/Siloxane modified montmorillonites, available from Nanocor, Inc.), from 15 to 30% by weight Nylon 6 (primarily Ultramid® B36 PA6 polyamide available from BASF Corporation, and may contain Selar® PA 3426 amorphous polyamide available from DuPont or similar grade), from 50 to 73% by weight LDPE (608A LDPE available from Dow or similar grade), and about 10% by weight of polyethylene-g-maleic anhydride (Bynel 41E710 adhesive resin available from Dow or similar grade) as a nylon tie.

The films having heat seal layers made from recycled resins contained from about 1% to about 5% by weight organically modified nanoclay (Nanomer® I.40P or I.44P nanoclays available from Nanocor, Inc.), from about 90% to about 98% scrap masterbatch material, which included 8% by weight RETAIN™ 3000 resin (Dow: Midland, Michigan) added as a compatibilizer. The Masterbatch included about 33% by weight nylon and about 67% by weight polyethylene. The polyethylene included major quantities of C4 LLDPE (appr. 40%), LDPE (appr. 30%) and C8 LLDPE (appr. 10%) and minor quantities of tie layer resins, EVA (low VA%), polybutylene and antifog (AF) masterbatch embedded in the polyethylene share. The compatibilizer was included in the polyethylene share.

The organically modified nanoclay was compounded into a blend of the native resins or scrap masterbatch in a single step and films were made as follows. The blend was used to produce a peeling layer in a coextrusion structure from a blown film line.

The films were sealed to a standard polyethylene film at 10° F. increments over a range of temperatures at 40 pounds per square inch with a one second dwell time. Seal strength was tested using an Instron tensile testing unit at a jaw speed of 12 inches per minute and a temperature of 73° F. according to ASTM F-88/F-88 - 09, “Standard Test Method for Seal Strength of Flexible Barrier Materials.

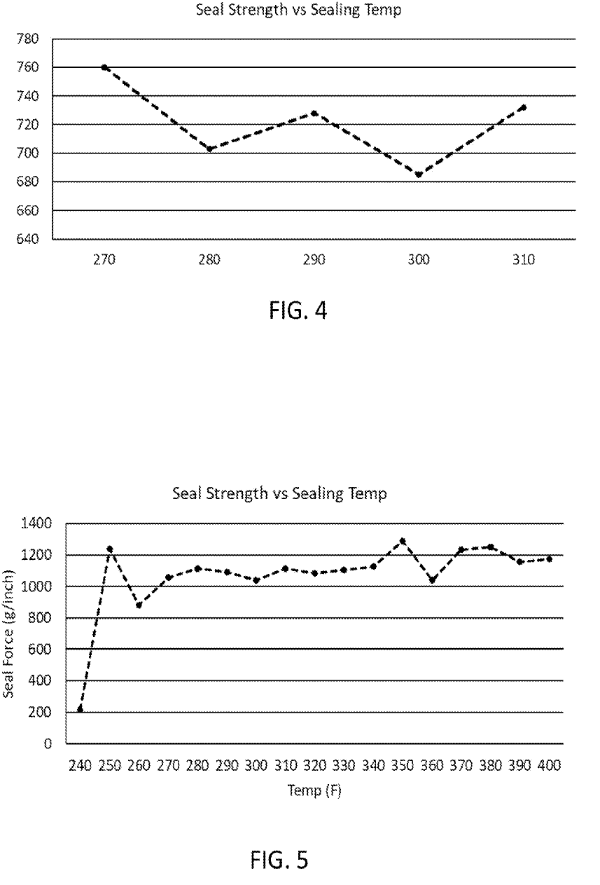

Seal strength at various seal temperatures was tested for five samples made from a lab line. Each sample included a 2 mil monolayer film made of 2.5% nanoclay with 98% PA scrap material. The results are shown in FIG. 4, which shows a consistent seal or peel strength (between 700 and 800 grams per inch) across a wide temperature range (270° F. to 310° F.).

An additional multilayer laminate film was tested to determine strength at various seal temperatures. The samples included a second heat seal layer of LLPPE/first heat seal (EZ peel) layer/LLDPE/oriented polyethylene terephthalate (OPET) structure. The EZ peel layer contained about 2.5% organically modified nanoclay, 30% polyamide (PA6), 5% RETAIN™ 3000 resin, 62.5% LDPE/LLDPE blend. The results are shown in FIG. 5, which shows a consistent seal or peel strength (between 800 and 1300 grams per inch) across a wide temperature range (230° F. to 400° F.).

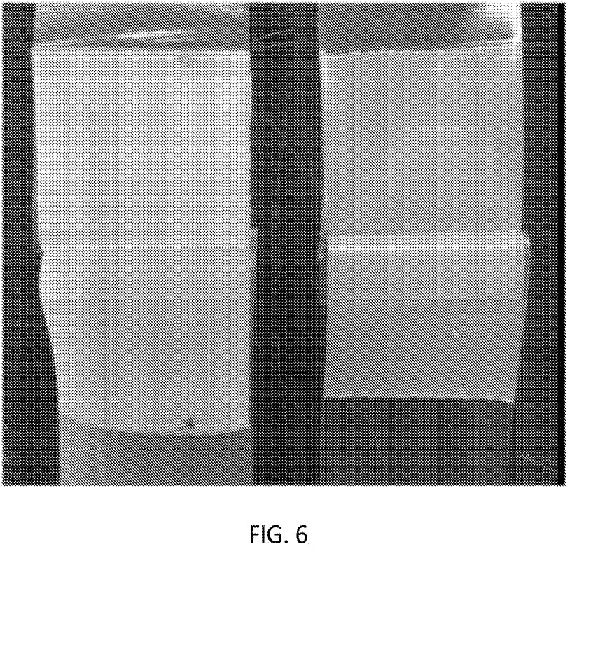

FIG. 6 shows an image in of partially peeled films. The film on the left corresponds to a film as described above regarding FIG. 5 in which the film was heat sealed to itself at 280° F. at 40 psi for 1 second, and the film on the right corresponds to a film (LDPE/EZ peel/LDPE/OPET) in which the EZ peel layer comprises polybutylene and polyethylene and in which the film was sealed to itself at 280° F. at 40 psi for 1 second. As shown, the peeled film having the heat seal layer comprising a polyolefin matrix, a polyamide dispersed in the matrix, and an organically modified nanoclay dispersed in the matrix appears substantially more white, indicating a better quality seal.

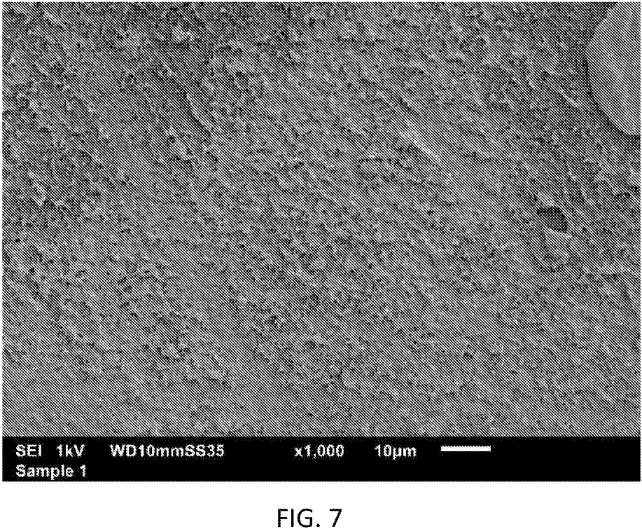

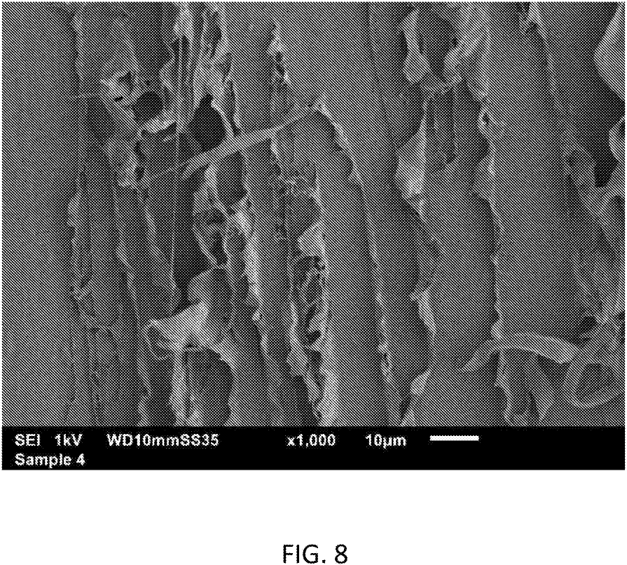

A scanning electron micrographic (1000X) image of the peeled film having the heat seal layer comprising a polyolefin matrix, a polyamide dispersed in the matrix, and an organically modified nanoclay dispersed in the matrix is shown in FIG. 7. A scanning electron micrographic (1000X) image of the peeled film having the heat seal layer comprising polybutylene and polyethylene is shown in FIG. 8. The films shown in the images in FIGS. 7 and 8 are the same as the films shown in FIG. 6. As shown, the peeled film having the heat seal layer comprising a polyolefin matrix, a polyamide dispersed in the matrix, and an organically modified nanoclay dispersed in the matrix exhibits less strings and webbing compared to the peeled film having the heat seal layer comprising polybutylene and polyethylene, indicating an improved quality seal.

The d-spacing of organically modified clay in an embodiment of a film having a heat seal layer as described herein was tested relative to a film having a heat seal layer without a polyamide was determined. The samples included a second heat seal layer of LLPPE/first heat seal (EZ peel) layer/LLDPE/oriented polyethylene terephthalate (OPET) structure. The EZ peel layer contained (i) about 2.5% organically modified nanoclay, 30% polyamide (PA6), 5% RETAIN™ 3000 resin, 62.5% LDPE/LLDPE blend, (ii) or about 2.5% organically modified nanoclay and 97.5% LDPE/LLDPE blend. The d-spacing of the organically modified nanoclay was determined via X-ray diffraction using a PANalytical X-ray diffractometer (Malvern Panalytical Ltd., Malvern, UK) using powder mode. The d-spacing is the distance between planes of atoms that give rise to diffraction peaks. Diffraction peaks were obtained from a diffractogram obtained via X-Ray Powder Diffraction (XRD) measurement. Each peak in a diffractogram results from a corresponding d-spacing.

The d spacing of organically modified nanoclay was 24.96 Å. The d spacing of 2.5% organically modified nanoclay in PE was 38.5 Å. The d spacing of 2.5% organically modified nanoclay in PE/PA re-pelletized scrap is 43.6 Å.

These results demonstrate that the presence of nylon in the heat seal layer enhances distribution of the organically modified nanoclay in the heat seal layer, which is indicative or more uniform distribution, which should lead to more uniform peel strength.

The peel strength of a film having a second heat seal layer disposed over a heat seal layer comprising a polyolefin matrix, a polyamide dispersed in the matrix, and an organically modified nanoclay dispersed in the matrix was tested after being heat sealed to itself at a number of temperatures. The samples included a second heat seal layer of LLPPE/first heat seal (EZ peel) layer/LLDPE/oriented polyethylene terephthalate (OPET) structure. The EZ peel layer contained about 2.5% organically modified nanoclay, 30% polyamide (PA6), 5% RETAIN™ 3000 resin, 62.5% LDPE/LLDPE blend. Sealing was done at 40 psi for 1 second. Seal strength was tested using an Instron tensile testing unit at a jaw speed of 12 inches per minute at 73° F. according to ASTM F-88/F-88 - 09, “Standard Test Method for Seal Strength of Flexible Barrier Materials. A peel force vs. distance curve was generated, with the peak of the curve recorded as peak strength.

The results are presented below in Table 1.

TABLE 1

Seal strength curve at various temperatures.

| | | | | | | | | | |
|---|---|---|---|---|---|---|---|---|---|
| temperature (F) | 270 | 280 | 290 | 300 | 310 | 320 | 330 | 340 | 350 |
| Average g/inch | 922 | 1094 | 1091 | 1044 | 1090 | 1079 | 1002 | 1164 | 1154 |
| peak g/inch | 1203 | 1379 | 1377 | 1372 | 1274 | 1557 | 1323 | 1465 | 1414 |

In addition, films were made without the presence of organically modified nanoclay and seal strength tested as described above. The films contained a second heat seal layer LLPPE/first heat seal (EZ peel) layer/LLDPE/oriented polyethylene terephthalate (OPET) structure. The EZ peel layer contained about 30% polyamide (PA6), 5% RETAIN™ 3000 resin, 65% LDPE/LLDPE blend. When such films were produced from a blown film lines, they were not able to be manually peeled. However, when produced from a cast lab line, the films could be manually peeled. The difference may be due to better dispersion of polyamide in the polyethylene matrix in the cast lab line (not tested). However, when the organically modified nanoclay was present in the EZ peel layers (as discussed above), the films exhibited EZ peel characteristics regardless of whether produced on a blown film line or a cast lab line.

30% PA alone (without organically modified nanoclay) should allow the film to exhibit easy peel properties regardless of processing conditions, because PA is not compatible with PE. However, in practice, it appears that processing conditions have a substantial impact on the ability of PA alone to provide easy peel characteristics. Differences in processing conditions, such as the degree of machine direction stretching, may affect the dispersion and the shape of the PA in the PE, which may ultimately affect its peel strength. As described herein the inclusion of the organically modified nanoclay overcame these limitations of PA alone to consistently provide easy peel characteristics.

Thus, films, layers, packages, packaged products, and methods for PEELABLE FILM HAVING NANOCLAY are described. Various modifications and variations of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are apparent to those skilled in film manufacturing or related fields are intended to be within the scope of the following claims.

It will be apparent to those skilled in the art that various modifications and variations can be made to the present inventive technology without departing from the spirit and scope of the disclosure. Since modifications, combinations, sub-combinations and variations of the disclosed embodiments incorporating the spirit and substance of the inventive technology may occur to persons skilled in the art, the inventive technology should be construed to include everything within the scope of the appended claims and their equivalents.

A number of embodiments have been described herein. A non-exhaustive list of nonlimiting embodiments are listed below. Any one or more of the features of these embodiments may be combined with any one or more features of another embodiment or aspect described herein.

Embodiment 1: A film comprising: a first heat seal layer comprising: (i) a heat sealable polyolefin matrix; (ii) a polyamide dispersed in the matrix; and (iii) an organically modified nanoclay dispersed in the matrix, wherein the polyamide is present in the first heat seal layer in an amount from 15 percent by weight to 45 percent by weight, and wherein the organically modified nanoclay is present in the first heat seal layer in an amount from 0.5 percent by weight to 10 percent by weight.

Embodiment 2: A film according to embodiment 1, wherein the d-spacing of the organically modified nanoclay in the first heat seal layer is 40 Angstroms or greater.

Embodiment 3: A film according to embodiment 1, wherein the d-spacing of the organically modified nanoclay in the first heat seal layer is 42 Angstroms or greater.

Embodiment 4: A film according to any one of embodiments 1 to 3, wherein the film provides a peel strength from 900 grams per inch to 1200 grams per inch when heat sealed to itself for 1 second at 40 pounds per square inch at a temperature in a range from 280° F. to 330° F.

Embodiment 5: A film according to any one of embodiments 1 to 4, wherein the film provides a peel strength from 900 grams per inch to 1200 grams per inch when heat sealed to itself for 1 second at 40 pounds per square inch at a temperature in a range from 270° F. to 350° F.

Embodiment 6: A film according to any one of embodiments 1 to 5, wherein the polyamide is present in the first heat seal layer in an amount from 20 percent by weight to 40 percent by weight.

Embodiment 7: A film according to any one of embodiments 1 to 6, wherein the organically modified nanoclay is present in the first heat seal layer in an amount from 1 percent by weight to 5 percent by weight.

Embodiment 8: A film according to any one of embodiments 1 to 6, wherein the organically modified nanoclay is present in the first heat seal layer in an amount from 2 percent by weight to 4 percent by weight.

Embodiment 9: A film according to any one of embodiments 1 to 8, wherein the polyamide comprises nylon 6.

Embodiment 10: A film according to any one of embodiments 1 to 10, wherein the heat sealable polyolefin matrix comprises polyethylene.

Embodiment 11: A film according to any one of embodiments 1 to 10, wherein the heat sealable polyolefin matrix comprises one or more of linear low density polyethylene (LLDPE), ultralow density polyethylene (ULDPE), ethylene-vinyl acetate (EVA), and low density polyethylene (LDPE).

Embodiment 12: A film according to any one of embodiments 1 to 11, further comprising a compatibilizer dispersed in the heat sealable polyolefin matrix.

Embodiment 13: A film according to embodiment 12, wherein the compatibilizer is present in the first heat seal layer in an amount from 0.5 percent by weight to 10 percent by weight.

Embodiment 14: A film according to any one of embodiments 1 to 13, wherein the first heat seal layer is an exterior layer.

Embodiment 15: A film according to any one of embodiments 1 to 13, further comprising a second heat seal layer in contact with the first heat seal layer.

Embodiment 16: A film according to embodiment 15, wherein the second heat seal layer is an exterior layer.

Embodiment 17: A film according to embodiment 15 or 16, wherein the second heat seal layer has a thickness from 0.2 mil (5.8 micrometers) to 2 mil (50.8 micrometers).

Embodiment 18: A film according to any one of embodiments 1 to 17, further comprising a functional layer and a tie layer.

Embodiment 19: A film according to embodiment 18, wherein the functional layer comprises a bulk layer, a barrier layer, or abuse-resistant layer.

Embodiment 20: A packaged product comprising: (i) a product; (ii) a film according to any one of embodiments 1 to 19; and (iii) optionally, a packaging structure, wherein the film is heat sealed to itself or the package structure to define an interior space, and wherein the product is disposed in the interior space.

What is claimed is:

1. A film comprising:
a first heat seal layer comprising:
a heat sealable polyolefin matrix;
a polyamide dispersed in the matrix; and
an organically modified nanoclay dispersed in the matrix,
wherein the polyamide is present in the first heat seal layer in an amount from 15 percent by weight to 45 percent by weight, and
wherein the organically modified nanoclay is present in the first heat seal layer in an amount from 0.5 percent by weight to 10 percent by weight.

2. The film of claim 1, wherein the d-spacing of the organically modified nanoclay in the first heat seal layer is 40 Angstroms or greater.

3. The film of claim 1, wherein the d-spacing of the organically modified nanoclay in the first heat seal layer is 42 Angstroms or greater.

4. The film of claim 1, wherein the film provides a peel strength from 900 grams per inch to 1200 grams per inch when heat sealed to itself for 1 second at 40 pounds per square inch at a temperature in a range from 280° F. to 330° F.

5. The film of claim 1, wherein the film provides a peel strength from 900 grams per inch to 1200 grams per inch when heat sealed to itself for 1 second at 40 pounds per square inch at a temperature in a range from 270° F. to 350° F.

6. The film of claim 1, wherein the polyamide is present in the first heat seal layer in an amount from 20 percent by weight to 40 percent by weight.

7. The film of claim 1, wherein the organically modified nanoclay is present in the first heat seal layer in an amount from 1 percent by weight to 5 percent by weight.

8. The film of claim 1, wherein the organically modified nanoclay is present in the first heat seal layer in an amount from 2 percent by weight to 4 percent by weight.

9. The film of claim 1, wherein the polyamide comprises nylon 6.

10. The film of claim 1, wherein the heat sealable polyolefin matrix comprises polyethylene.

11. The film of claim 1, wherein the heat sealable polyolefin matrix comprises one or more of linear low density polyethylene (LLDPE), ultralow density polyethylene (ULDPE), ethylene-vinyl acetate (EVA), and low density polyethylene (LDPE).

12. The film of claim 1, further comprising a compatibilizer dispersed in the heat sealable polyolefin matrix.

13. The film of claim 12, wherein the compatibilizer is present in the first heat seal layer in an amount from 0.5 percent by weight to 10 percent by weight.

14. The film of claim 1, wherein the first heat seal layer is an exterior layer.

15. The film of claim 1, further comprising a second heat seal layer in contact with the first heat seal layer.

16. The film of claim 15, wherein the second heat seal layer is an exterior layer.

17. The film of claim 15, wherein the second heat seal layer has a thickness from 0.2 mil (5.8 micrometers) to 2 mil (50.8 micrometers).

18. The film of claim 1, further comprising a functional layer and a tie layer.

19. The film of claim 18, wherein the functional layer comprises a bulk layer, a barrier layer, or abuse-resistant layer.

20. A packaged product comprising:
a product;
the film of claim 1; and
optionally, a packaging structure,
wherein the film is heat sealed to itself or the package structure to define an interior space, and wherein the product is disposed in the interior space.
